(19) United States
(12) Patent Application Publication
(10) Pub. No.: US 2025/0282921 A1
(43) Pub. Date: Sep. 11, 2025

(54) PROCESSING METHOD TO CROSSLINK POLYELECTROLYTE MEMBRANES AT USER-SELECTED HYDRATION LEVEL FOR CONTROL OF NANOSCALE MORPHOLOGY

(71) Applicants: Lawrence Livermore National Security, LLC, Livermore, CA (US); The University of Utah, Salt Lake City, UT (US)

(72) Inventors: James Spencer Oakdale, Castro Valley, CA (US); Thomas John Ferron, Livermore, CA (US); Auston Louis Clemens, Pleasanton, CA (US); John Joseph Karnes, Pleasanton, CA (US); Magi Yassa, Antioch, CA (US); Valeria Paula Molinero, Salt Lake City, UT (US)

(21) Appl. No.: 18/598,957

(22) Filed: Mar. 7, 2024

(51) Int. Cl. C08J 5/22; B01J 41/07; B01J 41/13; B01J 47/12; B33Y 80/00; C08G 65/48; C25B 13/08; H01M 6/18; H01M 8/10; H01M 8/1025; H01M 10/0565

(52) U.S. Cl. CPC C08J 5/2256; B01J 41/07; B01J 41/13; B01J 47/12; B33Y 80/00; C08G 65/485; C25B 13/08; H01M 6/181; H01M 8/1025; H01M 10/0565; C08J 2371/12; H01M 2008/1095; H01M 2300/0082

(57) ABSTRACT

A method of forming a membrane includes forming a membrane structure that includes a material comprising a polymer, a crosslinking agent, and a solvent. The membrane structure is equilibrated at a selected relative humidity for a predefined duration of time for forming hydrophilic domains in the material. The hydrophilic domains have a predefined average radius. The equilibrated membrane structure is cured to crosslink the material to at least a predefined extent.

This invention was made with Government support under Contract No. DE-AC52-07NA27344 awarded by the United States Department of Energy. The Government has certain rights in the invention.

### STATEMENT REGARDING PRIOR DISCLOSURES BY THE INVENTOR OR A JOINT INVENTOR

The following disclosure(s) are submitted under 35 U.S.C. 102 (b) (1) (A):

“Post-Hydration Crosslinking of Ion Exchange Membranes to Control Water Content,” Adam Barnett, John J. Karnes, Auston L. Clemens, James S. Oakdale, and Valeria Molinero, J. Phys. Chem. C. 127, made publicly available Mar. 13, 2023, pp. 5613-5621.

### FIELD OF THE INVENTION

The present invention relates to polyelectrolyte membranes, and more particularly, this invention relates to a processing method to crosslink polyelectrolyte membranes at user-selected hydration level for control of nanoscale morphology.

### BACKGROUND

The ion-conductive performance of a polyelectrolyte membrane hinges on its ability to form hydrophilic domains, commonly known as water channels. Ion transport within the membrane predominantly occurs within these domains, where ions traverse through a blend of diffusion, migration, and site hopping mechanisms. These processes are facilitated by anchored ionic sites intricately dispersed along the inner walls of the water channels. The size and winding nature of these channels are shaped by a myriad of factors, including the chemical attributes of the polymer's backbone, ion exchange content, and the length and frequency of ionic functional side-chains.

Polyelectrolyte membranes are typically used, but not limited to, as a physical separator for electrochemical devices that facilitate charge between cathode and anode within an electrochemical cell. The function of the membrane is a physical separator that separates products and reactants from either side of the device. The function of transporting selected ions through a physical barrier, and excluding other non-desirable ions, depends on a predefined charge of the system, where the charge is tethered to the polymers along water channels that preferentially form under hydration.

In numerous applications, the efficacy of polyelectrolyte membranes is contingent upon their proficiency in selectively transporting particular ions while excluding others, as well as any gaseous or liquid byproducts. The selectivity of these materials is closely tied to the dimensions and configuration of the water channels, in addition to the ion exchange capacity (IEC). Frequently, the dimensions of the water channels are intricately linked to the IEC, making it challenging to manage both selectivity and water uptake (WU) without modifying the IEC. This challenge can result in suboptimal performance, particularly at elevated IEC levels, where there is a disproportionate increase in water absorption and the expansion of hydrophilic channels.

### SUMMARY

According to one embodiment, a method of forming a membrane includes forming a membrane structure that includes a material comprising a polymer, a crosslinking agent, and a solvent. The membrane structure is equilibrated at a selected relative humidity for a predefined duration of time for forming hydrophilic domains in the material. The hydrophilic domains have a predefined average radius. The equilibrated membrane structure is cured to crosslink the material to at least a predefined extent.

According to another embodiment, a membrane includes a polymeric material having a plurality of hydrophilic domains configured to promote selective transport of a first ion and selective exclusion of a second ion. The extents of the hydrophilic domains are defined by an interface of the polymeric material and a water channel. The hydrophilic domains have an average radius greater than about 0.2 nanometers up to less than 10 nanometers in the presence of water.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic drawing of a desired phase of a membrane for an electrochemical cell, according to one embodiment.

FIG. 1B is a schematic drawing of a membrane for an electrochemical cell, according to one embodiment.

FIG. 2 is a flow chart of a method of forming a membrane for an electrochemical cell, according to one embodiment.

FIG. 3 is a plot of a computational simulation of water sorption isotherms showing the effect of crosslinking after partial hydration.

FIG. 4A is a plot of small angle X-ray scattering of membranes hydrated at varying relative humidity before crosslinking, according to one embodiment.

FIG. 4B is a plot of the radius-of-gyration extracted from small angle X-ray scattering modeling at varying relative humidity before crosslinking, according to one embodiment.

FIG. 5 is a plot of the conductivity of chloride ions transported through membranes hydrated at varying relative humidity before crosslinking, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of a processing method to crosslink polyelectrolyte membranes at user-selected hydration level for control of nanoscale morphology and/or related systems.

In one general embodiment, a method of forming a membrane includes forming a membrane structure that includes a material comprising a polymer, a crosslinking agent, and a solvent. The membrane structure is equilibrated at a selected relative humidity for a predefined duration of time for forming hydrophilic domains in the material. The hydrophilic domains have a predefined average radius. The equilibrated membrane structure is cured to crosslink the material to at least a predefined extent.

In another general embodiment, a membrane includes a polymeric material having a plurality of hydrophilic domains configured to promote selective transport of a first ion and selective exclusion of a second ion. The extents of the hydrophilic domains are defined by an interface of the polymeric material and a water channel. The hydrophilic domains have an average radius greater than about 0.2 nanometers up to less than 10 nanometers in the presence of water.

A list of acronyms used in the description is provided below.
3D three-dimensional
AEM alkaline electrolyte membrane
CPPO chloromethylated PPO
DABP 4,4′-diazido-2,2′-dimethylbiphenyl
IEC ion exchange capacity
ms millisecond
nm nanometer
PPO poly(phenylene oxide)
RH relative humidity
QPPO quaternized PPO
SAXS small angle x-ray scattering
TMA trimethylamine
μm micron
UV ultraviolet
wt % weight percent
WU water uptake

Polyelectrolyte membranes are thin solid sheets of a polymer matrix capable of conducting ions and are typically used as but not limited to, physical separators that facilitate charge transfer between cathode and anode within an electrochemical cell. A polyelectrolyte membrane's performance is dependent on the formation of nano-scale water channel formation and their relative size and tortuosity. A processing method is described that controls the size of the nanostructure by physically crosslinking polyelectrolyte membranes that are equilibrated with a prescribed relative humidity of the surrounding environment by exposing a sample prepared with a UV active small molecule crosslinker additive to ultraviolet light.

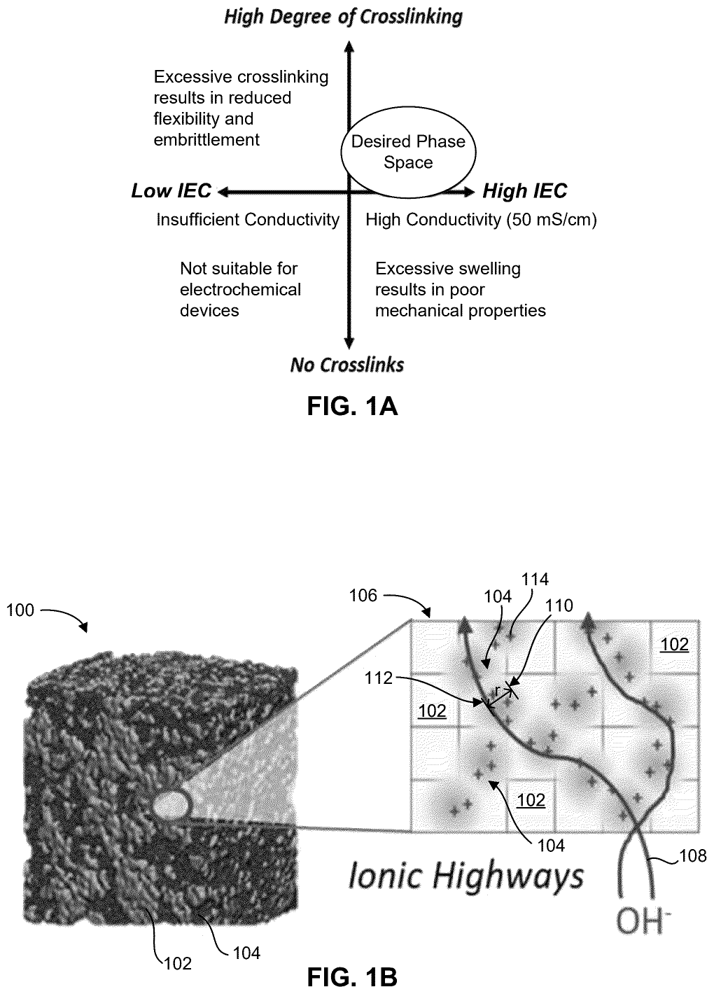

As illustrated in a schematic drawing of FIG. 1A, forming a membrane for optimal electrochemical function includes consideration of crosslinking and ion exchange capacity (IEC) of the membrane material. Prior approaches have juggled the irreconcilable interplay of mechanical and transport properties, with effort devoted to the control of water uptake in ionomer membranes so that both high ion exchange capacity (IEC) values and mechanical stability may be achieved simultaneously. The introduction of chemical crosslinks to the membrane architecture has been one of the most successful among these methods. Various studies have reported crosslinks that can be made through a variety of chemical linkages between polymer strands and ultimately result in membranes with web-like, interconnected polymer networks held together by covalent bonds in addition to van der Waals forces and entanglement. The addition of these linkages has been shown to increase Young's modulus and decrease water uptake by as much as 50%. However, excessive crosslinking results in reduced flexibility and embrittlement of the membrane material.

The conventional standard procedure for creating crosslinked membranes is to cast the polymer dissolved in solution, remove the organic solvent, crosslink the polymer slab, and then hydrate the fully crosslinked membrane. This procedure results in high polymer gel fractions (the portion of the polymer that cannot be redissolved due to high molecular weight), indicating a sufficient degree of crosslinking. Moreover, the conventionally-formed membranes depend on the chemical architecture environment where the membrane is crosslinked before exposure to a humid environment. Conventional approaches to forming a polyelectrolyte membrane having enhanced properties typically include chemical modifications such as tethering cationic groups to the backbone using alkyl spacers. These conventional approaches lead to improved long-range ordering and the promotion of ionic cluster aggregation. The addition of chemical modification, such as alkyl spacers between the polymer backbone and cationic sites, limits the flexibility of physically tailoring a generic polymer membrane to different device requirements on demand. This approach includes changing the material feedstock. The backbone modification approach is more complex and costly and results in an inflexible, non-transferable ad hoc solution to a specific operating environment.

A desired phase space of forming an ionomer membrane includes a significant level of crosslinking and high conductivity for high IEC. A membrane material that uptakes water too easily and results in excessive swelling has poor mechanical properties. According to one embodiment, a membrane includes mechanical strength and potential for high IEC because the detrimental effect of excessive swelling with water is restricted.

FIG. 1B depicts a schematic diagram of a membrane 100 for transporting ions in an electrochemical cell, in accordance with one aspect of an inventive concept. As an option, the present membrane 100 may be implemented in conjunction with features from any other inventive concept listed herein, such as those described with reference to the other FIGS. Of course, however, such membrane 100 and others presented herein may be used in various applications and/or in permutations which may or may not be specifically described in the illustrative embodiments listed herein. Further, the product 100 presented herein may be used in any desired environment.

According to one embodiment, a membrane includes a polymeric material having a plurality of hydrophilic domains, where the plurality of hydrophilic domains are configured for selected transport of ions and selective exclusion of non-desired ions. As illustrated in FIG. 1A, a membrane 100 includes a polymeric material 102 and a plurality of hydrophilic domains 104. The expanded view 106 of a portion of the membrane illustrates the hydrophilic domains 104 within the polymeric material. The polymeric material 102 is configured to form water channel 108 though the membrane 100. The water channels 108 follow and proceed through hydrophilic domains 104 of the membrane 100.

The extents of the hydrophilic domains are defined by an interface 110 of the polymeric material 100 and a water channel 108. A preselected charge 114 may be incorporated in the polymeric material 102 that provides creates an ionic highway for transporting a selected ion through the membrane. The hydrophilic domains have an average radius r that may be defined between the interface 110 and the center 112 of the water channel 108. In preferred approaches, the hydrophilic domains have an average radius r greater than 0.2 nanometers (nm) up to less than 10 nm in the presence of water. In one approach, the hydrophilic domains may have an average radius in a range of greater than 0.5 nm up to less than 5 nm in the presence of water. In one approach, the hydrophilic domains may have an average radius greater than 0.6 nm up to less than 2 nm.

According to various approaches, the characteristic diameter of a majority of the hydrophilic domains in a membrane is in the nanoscale range. The hydrophilic domains self-assemble into network of nanoscale water channels that percolate the membrane, permitting transport through the membrane from one side to the opposite side of the membrane. In some approaches, greater than 90% of the hydrophilic domains of the membrane are nano-segregated. For example, greater than 90% of the hydrophilic domains have an average radius less than 10 nm, less than 5 nm, less than 2 nm, etc.

Without wishing to be bound by any theory, it is believed that water uptake assessments of membranes may not represent size of channels in the membrane. For example, the before crosslinking, the formed membrane may uptake significant water but the formed channels in the formed membrane may not represent large channels but rather an increase in smaller channels throughout the polymer. For a given water content, if large channels are formed in a membrane, then there are a fewer number of channels in the membrane. Regarding water uptake in polymers, both size and volume of the water channels may be considered. A “number” of channels may not necessarily represent individually distinct channels that are separated, but likely represent a bi-continuous network. Given a constant volume fraction of water (from WU), a membrane having larger channels will likely represent a network that is less tortuous. A less tortuous network has fewer branching paths that in turn lowers the “number” of channels.

In preferred approaches, the membrane may be configured to have a predefined water content that is constant in the presence of a hydration condition. In various approaches, the hydration condition may be in a range of greater than 10% up to near 100% relative humidity. For example, in the presence of 98% relative humidity, the water content of the membrane remains stable and does not demonstrate significant uptake of water.

In one approach, the membrane is a polyelectrolyte membrane. In one example, the polymeric material may include quaternized poly(aryl ether) polymers. Polymers such as poly(phenylene oxide) (PPO) and polysulfone are well known as an inexpensive polymer backbones within alkaline electrolyte membranes (AEMs) due in large part to their commercial availability, ease of quaternization and/or functionalization, and good mechanical strength. However, poly(aryl ethers) also display sub-optimal alkaline stability arising from their labile ether linkages, which upon hydroxide-mediated cleavage result in chain-scission events. In preferred approaches, PPO may be functionalized through a chloromethylation reaction to form a quaternary ammonium functional poly(phenylene oxide) (QPPO). The polymeric material includes a nitrene crosslinking agent.

In various approaches, hydrophilic domains self-assemble during hydration to a lowest energy state when the membrane is fully hydrated. A lowest energy state of the hydrophilic domains may include cation charges exposed on the edges of the hydrophilic domains that form the walls of the water channels. Referring back to FIG. 1B, self-assembled hydrophilic domains 104 of the membrane 100 have exposed cations 114 on the channel side of the interface of the polymeric material 102 and the water channel 108. As described herein, the polymeric membrane is hydrated in up to 98% relative humidity before crosslinking. Following hydration, the self-assembled hydrophilic domains in the polymeric material are set by crosslinking the polymeric material by a curing step with UV light.

In preferred approaches, the size of the water channels in a membrane has hydrophilic regions having optimal surface area for ion interaction. The mass percent of water in a membrane may not describe, define, etc. the size of the water channels in the membrane. For example, a membrane having larger channels may accommodate a similar mass percent of water as a membrane with smaller water channels. Theoretically, the optimal size of the water channels corresponds to the efficiency of the transport of the desired species in selected permeable membranes. Moreover, the water channels may be formed for selectivity of transport of different ion species, such as the size of the water channels may correspond to the transport of one ion species relative to another ion species. For example, the functional groups that facilitate transport of the ionic molecules may be primarily present at the polymer-water interface on the surface of the water channels. Small capillary-type channels provide more surface area for contact between charged molecules and specific functional groups at the polymer-water interface, in other words the charged molecules shuttle along the surface of the smaller water channels. In contrast, larger channels have a larger space in the center of the channels (e.g., the dead zone) where there is no interaction with the functional groups that facilitate the transport of desired molecules.

In one example, comparing the size of the hydrophilic domains of a membrane completely dehydrated followed by crosslinking (i.e., conventional approach) and a membrane completely hydrated followed by crosslinking (i.e., approach described herein), the size of the hydrophilic domains (e.g., water channels) in a membrane may be changed to 2× the size, and this difference may change the conductivity of the material. The performance of a membrane crosslinked post-hydration may have improved conductivity that mirrors the change in size of the hydrophilic domains. The discrepancies between a performance value from a membrane crosslinked at a dehydrated state (e.g., performance value=10) compared to a performance value from a membrane crosslinked at a hydrated state (e.g., performance value=20) may be significant for any device performance. The methodology as described herein may be applied to any type of polymer backbone structure.

According to one embodiment, hydrating a polymer membrane before crosslinking may offer two major benefits. The first benefit is the control over the degree of hydration within the membrane. By forming the membrane and allowing the membrane to absorb a limited amount of water before the structure of the polymer is set, we aim to make the water content a controllable design parameter set during membrane creation, not merely a variable that behaves as a strong function of IEC and water activity (a_{w}.) This would allow overloading of the ionic content while decoupling IEC from water sorption. Without being bound by any theory, it is believed that the excess ion capacity in the crosslinked channels may help prevent the degradation spiral observed when loss of ionic groups leads to drying of the membrane, locally reducing the water content, and further increasing the rate of chemical degradation of the membrane.

A second potential benefit of post-hydration crosslinking is the spatial control over the location of the crosslinks. The utilization of a phase-transfer catalytic strategy where an aqueous catalyst promotes crosslinking at the water-polymer interface may prevent rearrangement of the polymer in intimate contact with the electrolyte, mitigating water uptake. However, crosslinks predominantly located at the interface could effectively minimize connectivity within the interior of the hydrophobic phases, which play a key role in preventing the exponential water uptake of water at high RH. An “interfacial” crosslinking may be a worst-case scenario with respect to mitigation of exponential water uptake and this “interfacial” preference is adopted as a conservative approach in our proof-of-concept water sorption studies.

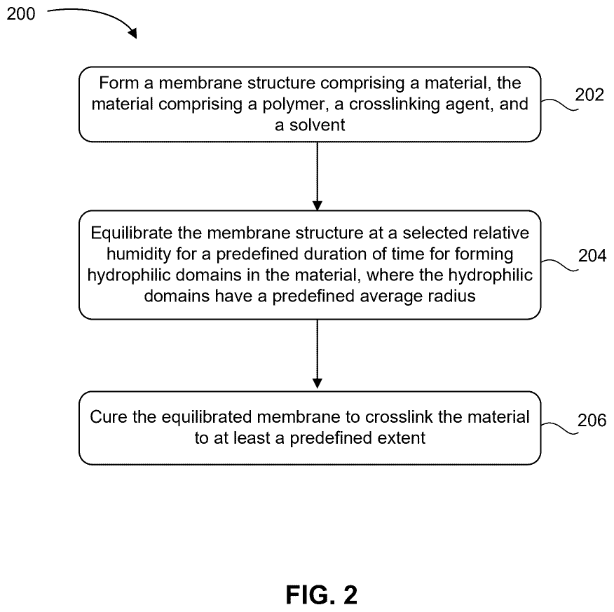

FIG. 2 shows a method 200 for forming a membrane, in accordance with one aspect of one inventive concept. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative embodiments listed herein. Further, the methods presented herein may be conducted in any desired environment. Moreover, more or less operations than those shown in FIG. 2 may be included in method 200, according to various embodiments. It should also be noted that any of the aforementioned features may be used in any of the embodiments described in accordance with the various methods.

As described herein, an approach to crosslinking methodology includes a membrane is formed, organic solvent is removed, and the membrane is allowed to absorb water to a low level of hydration by equilibrating it at a controlled relative humidity (RH) before crosslinking the polymer to prevent exponential water uptake when equilibrated at 100% RH. According to one embodiment, a method 200 of forming a membrane may begin with operation 202 of forming a membrane structure that includes a material. The material includes a polymer, a crosslinking agent, and a solvent.

In one approach, the polymer may include quaternized poly(aryl ether) polymers. Polymers such as PPO and polysulfone are easily quaternized and/or functionalized, and good have mechanical strength. In preferred approaches, PPO may be functionalized through a chloromethylation reaction to form a quaternary ammonium functional poly(phenylene oxide) (QPPO).

In one embodiment, the material includes a crosslinking agent that is not utilized until after hydration of the polymer. Post-hydration crosslinking reduces the water uptake of ionomer membranes. As described herein, a small crosslinker type additive is mixed in the material forming the electrolyte membranes. The small crosslinker type additive preferably includes diazide functional groups. In one aspect, relying only on A-B click chemistry between groups located adjacent to water channels may not result in enough crosslinking to reach a sufficiently high gel fraction. Thus, using a small molecule diazide crosslinking agent that decomposes into indiscriminate nitrene groups allows crosslinking to occur with most chemical sites on a polyelectrolyte membrane. For example, nitrene groups may react through insertion from aromatic conjugation, deprotonation of alkyl protons (e.g., addition), crosslinking through radicals, etc. As described herein, crosslinking after forming and partial hydration of the membrane includes the use of a diazide crosslinking agent that is configured to dissolve in the hydrophobic domains and the indiscriminate reactivity of nitrenes may crosslink the polymer within the self-assembled hydrophobic domains.

In conventional processes, polyelectrolyte membranes may be crosslinked by different types of crosslinking agents for different outcomes. As described herein, crosslinking a membrane after hydration and self-assembly of nano-segregated hydrophilic domains, a preferred crosslinking agent includes small molecule diazide crosslinking having functional groups for azide assisted crosslinking. In preferred approaches, the small molecule diazide crosslinking agent is incorporated in the polymeric material before hydration thereby being distributed throughout the material during self-assembly of the hydrophilic domains in the polymeric material during hydration. Curing of the material after hydration includes activating the diazide molecules to crosslink neighboring polymer chains and set the hydrophilic domains that were self-assembled during hydration. The small molecule diazide during curing decomposes into a nitrene reactive group that reacts with most chemical sites of neighboring polymer.

As described herein, post-hydration crosslinking includes incorporation of reactive crosslinking agents (e.g., reactive molecules such as diazides) during the fabrication of the polymer, followed by partial hydration of the membrane to allow for the development and connectivity of the water channels, and then activation of the diazide molecules with UV light to unselectively crosslink the polymer matrix. In some approaches, curing may include thermal curing where the diazide molecule is activated with applied heat (e.g., above 130° C.).

In one approach, a small molecule crosslinker preferably includes azide functional groups, an azide represented by three nitrogen groups. In preferred approaches, the crosslinking agent is a nitrene crosslinking agent. In an exemplary approach, a small molecule crosslinker includes aryl-type azide functional groups where the three nitrogen groups are adjacent to an aromatic benzene ring. An aryl-type position may be defined as the nitrogen groups being positioned directly adjacent to the aromatic ring such that no carbon group is positioned in between the nitrogen atom and the aromatic ring.

In preferred approaches, a small reactive crosslinking agent is a diazide molecule having two azide functional groups. Diazide-crosslinking has been shown to prevent an exponential water uptake in a crosslinked polymer and the ordering and position of the nitrogen groups on the azide molecule affects the crosslinking efficiency. The small molecule crosslinker may be designed such that the functional groups function in a similar manner. An exemplary approach to the processing method includes the small molecule crosslinkers possessing two or more aryl positioned azide functionalities. These azide groups are crucial for azide degradation into nitrene, enabling effective C—H crosslinking insertion into neighboring polymer chains. In one approach, the method utilizes a UV-active small molecule crosslinker integrated into the polymer network via sonication and evaporation fabrication. The integrated small molecule crosslinker remains inactive in the material until activated with UV after hydration of the material.

The approach as described herein utilizes activation and reaction of the diazide crosslinking molecule with the surrounding (e.g., neighboring) polymer, and does not involve the proximity of an excessive amount of diazide in the matrix. Thus, a small amount of diazide crosslinking agent may be sufficient to achieve a high degree of specific crosslinking that does not affect the IEC by introducing excess organic bulk in the form of unreacted groups. In various approaches, an amount of diazide crosslinking agent may be in a range of 0.25 wt. % up to 10 wt. % of polymer in the material for forming the membrane structure. In one approach, a diazide crosslinking agent is 4,4′-diazido-2,2′-dimethylbiphenyl (DABP).

According to various approaches, a solvent is included in the material mixture for forming the membrane structure. In preferred approaches, the solvent is an organic solvent. The solvent is selected to dissolve the crosslinking agent in the polymer so that the crosslinking agent is distributed uniformly throughout the material. Preferably, the crosslinker exhibits solubility in the selected solvent used during the evaporation fabrication process for the final membrane form factor preparation. According to one approach, the polymer and crosslinking agent are dissolved in a selected solvent, followed by casting, spin coating, printing, etc. the material into the form of a membrane.

In some approaches, the formed membrane is a three-dimensional (3D) structure. In one approach, the formed membrane is a cast structure. In one approach, the material is used in additive manufacturing process to form a printed 3D structure having features and voids.

The fabrication process of forming a membrane structure includes evaporation of the solvent from the formed structure of material. In one approach, evaporation of the organic solvent from the material results in a thin film. The process of evaporation of the solvent is determined according to the solvent. In one example, using a solvent such as N-methylpyrolidinone may include incubation of the material at 60° C. temperature for an effective amount of time (e.g., about 24 hours) to remove the solvent from the material. In another example, a solvent may be used to form a membrane and subsequently be removed by evaporation at room temperature for one hour. Solvents that have a lower boiling point may be removed from the material in a shorter amount of time.

Operation 204 of method 200 includes equilibrating the membrane structure at a selected relative humidity for a predefined duration of time for forming hydrophilic domains in the material. The films are then hydrated, which leads to phase segregation and formation of ionic channels (as illustrated in FIG. 1A) as the membrane reaches a steady-state morphology. The hydrophilic domains are formed having a predefined average radius.

Since crosslinking can disrupt phase segregation, resulting in loss of ion conductivity and significant osmotic stresses that lead to cracking or crazing behaviors, the method includes a cross-linking strategy in which crosslinks will be introduced post hydration and post-nanophase segregation. Crosslinking post hydration allows the material to self-organize under controlled humidity conditions before locking the structure into place.

Once the desired solid form factor is attained, the membranes are transferred to a controlled humidity cell. The formed membrane structure is equilibrated in a preselected relative humidity for a duration of time. At a relative humidity of around under 10% relative humidity up to greater than 90% relative humidity (e.g., up to 98% relative humidity), the formed membrane structure uptakes the water from the humid environment. In a preferred approach, the relative humidity in the controlled environment is selected from a range of greater than 10% up to less than 100% relative humidity. In an exemplary approach, the membrane is under the highest relative humidity (greater than 98% relative humidity); however, the membrane is not submerged in water bath. In other words, the membrane is equilibrated and then cured without being submerged in water. The preferred approach is to hydrate the membrane as much as possible using exposure to relative humidity without submerging the membrane in water.

A membrane submerged in a water bath does not result in similar trends as seen with a humid atmosphere. It is unknown whether the crosslinker may be leached out of the membrane structure during submersion in a water bath or whether the presence of water changes the way the channels are formed in the membrane. Without wishing to be bound by any theory, it is believed that in a liquid bath molecules within the membrane are free to move about and possibly leach away from the membrane; whereas in a humid environment the molecules are constrained within the polymer membrane (e.g., the membrane retains its structural integrity), and thus, there is less propensity for the crosslinker molecules to leach out of the structure. In preferred approaches, the hydrated environment may be in a range of greater than 10% up to 98% relative humidity.

In one approach, a formed membrane structure uptakes a certain amount of water in ambient relative humidity (e.g., less than 10% relative humidity), and then exposure to a humid environment up to about 98% relative humidity causes the channels to swell to a certain extent thereby increasing in size (e.g., having larger radii than channels at ambient relative humidity). However, the enlarged water channels remain at nanoscale size. For example, swollen water channels (e.g., hydrophilic domains) at high relative humidity may have an average radius in a range of 0.5 nm up to about 5 nm. The channels may be larger or smaller.

Formation of the polymer membrane includes synthesizing an organic component and then exposure of the organic component to water causes the microscopic network of water channels within the organic component to self-assemble. By varying the humidity, the morphology of the microscopic network of water channels varies, the network of water channels are allowed to self-assemble, and then the polymer membrane having the self-assembled channels is exposed to UV light to crosslink the polymer into a set configuration of water channels. The morphology is in place locked in the structure of the water channels. This approach is different than the conventional approach that involves forming the crosslinked polymer membrane and then submerging the polymer membrane in a water bath after crosslinking the membrane; however, this varies the membrane integrity, and the membrane degrades and ages as it is stressed.

According to various approaches, operation 204 may be tuned to equilibrate the formed membranes with a selected relative humidity to result in a membrane that has hydrophilic domains having a predefined size. The desired size of the water channels (e.g., hydrophilic domains) is nanoscale, and may have an average radius in a range of greater than 0.5 nm to 5 nm. In one example, the sizes for the hydration studies have a range of a radius from 0.7 nm to 2.0 nm., so an average diameter of the channels may be in a range of 1.2 nm to about 4 nm.

In some approaches, a formed membrane may be added to a chamber that includes a well containing an aqueous saturated solution to control humidity of the head space and for generating a selected relative humidity. A selected relative humidity may be facilitated using a commercial humidity controlled chamber. An internal UV lamp may be included in the humidity controlled chamber to proceed with crosslinking following hydration of the membrane.

In various approaches, the predefined duration of time is an effective amount of time to cause the formed membrane to be equilibrated with the humidity-controlled environment. The predefined duration of time for incubation of the formed membrane in a humid environment to equilibrate the membrane in the selected relative humidity may be in a range of greater than 10 minutes up to 72 hours. The duration of time may depend on the type of polymer used to form the membrane, the extent of increase in relative humidity, etc. In one example, a material may be equilibrated at a selected relative humidity in a duration of time ranging from 10 minutes to 110 minutes.

Operation 206 of method 200 includes curing the membrane to crosslink the material to at least a predefined extent, where the hydrophilic domains have a predefined average radius. After hydration, the material is exposed to a UV light to crosslink the hydrated material, thereby chemically reinforcing the material under a pre-selected hydration values. The formed membrane having swollen channels (e.g., enlarged channels) may be cured using exposure to UV light to lock the nanostructure into place. The humidity-affected channels changes the conductivity of the channels and increases the ease of the transport of ions through the channels.

According to one approach, the hydrated formed membrane is exposed to radiation (UV light) for an effective amount of time to activate the crosslinking agent to efficiently crosslink the material in the hydrated state. The wavelength of the UV light is determined according to the crosslinking agent. In one example, the equilibrated membranes are subsequently exposed to a 365 nm centered wavelength lamp, with an intensity of 135 mW/cm², for a duration of 30 minutes. During this exposure, a significant portion of the azide chemical moiety is consumed, leading to effective crosslinking.

The curing parameters may be increased or decreased to affect the curing intensity, shorten the reaction time, etc. There is a threshold of the intensity of curing, and wavelength to achieve groups to react in the water channels. Crosslinking the membranes is to prolong their usability, they can last longer.

Following the curing process, the microstructure is locked into place chemically and can be further processed for utilization and characterization. According to one approach, crosslinking the material after hydration may result in crosslinks localized within self-assembled polymer domains. This approach may be more efficient at precluding water uptake. In sharp contrast to the nonspecific connectivity that randomly spans a conventionally crosslinked homogenous polymer monolith formed following conventional approaches that crosslink the membrane material before hydration, the embodiment described herein includes spatial control toward maximizing the influence of each crosslink. The approaches described herein may minimize the amount of crosslinking introduced to the membrane material thereby benefiting the design of anion exchange membranes. Excess crosslinking is undesirable because excessive crosslinking tends to result in embrittlement of the polymer by lowering its effective degree of entanglement.

In prior approaches, molecular dynamics simulations assessed the feasibility of producing sufficiently crosslinked membranes through the reactivity of groups displayed in the hydrophilic channels. In this study, the water uptake of membranes that are crosslinked after being formed and partially hydrated was investigated. Despite these unique benefits, molecular simulation studies of water sorption isotherms in systems as complex as ionomer membranes are rare. The main limitations have been the high computational cost of grand canonical simulations with all-atom models and the scarcity of data validating the simulated structure and water activity of ionomer membranes.

Crosslinking of ionomer membranes is an effective way to decrease their water uptake without the need to decrease ion exchange capacity and lower their conductivity. Crosslinks create a polymer web that limits the mobility of individual polymer chains in a membrane, opposing the intrusion of water. Conventional methods of polymer membrane formation typically includes castings and crosslinking the membrane material in an anhydrous state. As described herein, an alternative approach to crosslinking the membrane after fabrication includes allowing for limited hydration at low relative humidity. This post-hydration strategy allows the membrane to establish well-developed and connected water channels within the polymer matrix and to enable the selective location of the crosslinks in the hydrophobic or hydrophilic domains.

Model simulations of PPO-TMA polymers demonstrate the feasibility of crosslinking after partial hydration. The modeling predictions of gel fraction versus crosslinking for membranes made with experimentally relevant DP 200 PPO-TMA polymer chains were consistent with experimental gel fractions, supporting the approach that relatively few crosslinks are required to create a highly interconnected network that can resist water uptake. Computing the sorption isotherm of a PPO-TMA membrane crosslinked to reach a gel fraction of 95%, which is comparable to a gel fraction achieved in conventional approaches of crosslinking the membrane immediately after casting during evaporation, showed reduction in water uptake by about a factor of 3. This reduction is comparable to or higher than that achieved with standard pre-casting crosslinking. Without wishing to be bound by any theory, it is believed that since the immobilization of the hydrophobic domains is effective at quelling the uptake of water at high RH, post-hydration crosslinking may serve as a viable strategy to reduce excess water sorption by ion exchange membranes.

This process allows for the development of a nano-segregated morphology, which establishes well-connected but narrow water channels, while limiting additional sorption of water. The significant reduction in membrane swelling during hydration of the crosslinked membrane indicates that post-hydration crosslinking may be a promising approach to regulate water uptake in ion exchange membranes.

According to one embodiment, performance of polyelectrolyte membranes is enhanced using a humidity-controlled crosslinking process that may be applied to precisely adjust the hydrophilic structure of the membrane. This approach allows for performance optimization without necessitating alterations to the fundamental chemistry, thereby enabling the tailoring of the membrane to suit the specific demands of the intended application.

In other approaches, adjusting the quantity of crosslinker added, incorporating additives, and modifying the IEC have been explored to modify relative conductivity and/or selectivity of the polyelectrolyte membrane. As described herein, according to one embodiment, a process of forming a membrane introduces an additional parameter for controlling membrane performance without the need to alter the chemical constituents. Consequently, this process lends itself to on-demand, purposeful batch variability, based on processing conditions, offering an economical approach for customizing materials on a large scale, particularly for industrial manufacturing.

As described herein, the process may not include adjusting the architecture of the membrane before crosslinking, rather, application of a humid environment, e.g., up to 98% relative humidity, before crosslinking the membrane changes the size of the channels of the membrane, and following crosslinking the membrane to set the channels results in enhanced performance of the membrane. As described herein, physical phenomena may be applied to the membrane, before crosslinking the membrane material, and used to change the performance of the membrane.

In some approaches, a choice of an alternative diazide crosslinking agent may result in crosslinks in the polymer that selectively partition into the hydrophobic domains of the membrane, leading to crosslinks within the glassy domains. It may be noted that crosslinking through the hydrophobic domain would be the most effective at preventing the feedback between water sorption and plasticization of the polymer matrix, which may be responsible in part for the exponential uptake of water by ion exchange membranes exposed to high relative humidities. In some approaches, examination of crosslinking processes may include establishing a suitable “zeroth-order” harmonic bonds between hydrophobic moieties of the polymer backbone to approximate those generated by a model diazide. As described herein, crosslinking associated with the “hydrophilic channel” approach successfully demonstrates water uptake mitigation.

### EXPERIMENTS

### Computational Simulations of Post-Hydration Crosslinking.

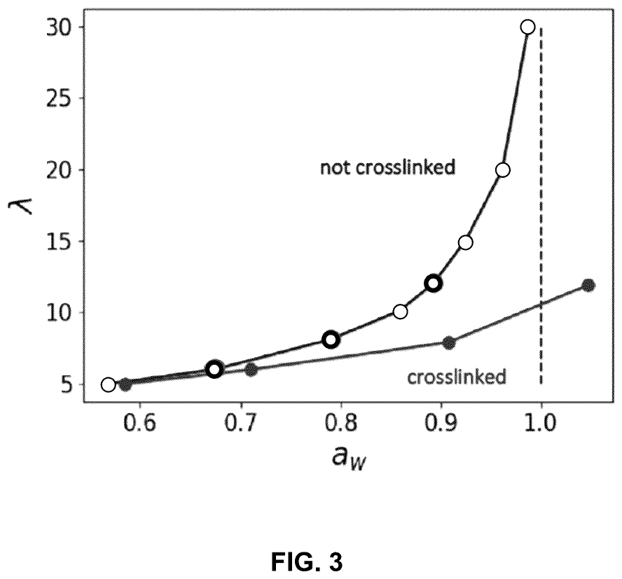

Computational simulations included calculating water sorption isotherms in crosslinked membranes. A swelling procedure was validated by comparing the sorption isotherm of the PPO-TMA membrane without crosslinking, and the same membranes prepared and equilibrated independently at various water contents. FIG. 3 illustrates water sorption isotherms that result from un-crosslinked (◯) and 20% crosslinked (●) DP 20 membranes after partial hydration. The water sorption isotherms of un-crosslinked include results form two different approaches of water sorption (indicated by bold or standard line thickness symbols, ◯), and the resulting curves are similar by both approaches.

FIG. 3 shows excellent agreement in the number λ of water molecules per cation in the membranes as a function of water activity a_{w} prepared by these two methods. This indicates that the membrane configurations obtained during the swelling procedure are representative of the structure adopted by the polymer matrix at that water content. Therefore, the water sorption isotherms created using a swelling procedure are representative of the corresponding membrane and agnostic of its starting hydration level, probing only the effect of the addition of crosslinks after partial hydration.

Due to the high computational cost of the computational simulations, the sorption isotherm of a single crosslinked membrane may be calculated. Introduction of crosslinks across the hydrophilic channels may provide a worst-case scenario toward mitigating excess water uptake since it is expected that membranes with crosslinks in the hydrophobic domains will most effectively prevent the plasticization and unraveling of the polymer domains at high RH.

FIG. 3 shows the water uptake of the membrane with gel fraction 95%, achieved with DP 20 polymers with 20% crosslinks stitching through the hydrophilic domains. The water uptake is lower than for the un-crosslinked membrane at all water activities. The crosslinked membrane reaches λ˜10 at q_{w}=1 (i.e., at 100% RH). That water uptake is just ˜⅓ of that of the un-crosslinked membrane. The 3-fold reduction observed in our simulations is more pronounced than the 2-fold reduction experimentally determined for aromatic polymer membranes with similar gel fractions. These results show that post formation and partial hydration and crosslinking can be effective in controlling the water uptake of ionomer membranes.

### Formation of Membrane Material—Synthesis of CPPO Ionomer

Chloromethylation of PPO, (CPPO): PPO (8.0 g, 66.6 mmol) was dissolved in 500 mL of CHCl₃ in a 1 L round bottom flask equipped with a stir bar. The reaction vessel was brought to 40° C. 0.75 mL SnCl4 (1.69 g, 6.5 mmol) was added followed by dropwise addition of 40 mL TCMS (50.8 g, 339.8 mmol). After 4.2 h, the polymer solution was precipitated in 1 L of methanol and stirred for 30 minutes to ensure the absence of undesired side reactions that result in unwanted gelation, which can occur in PPO chloromethylation. Precipitated CPPO was then filtered and washed 3 times with methanol. CPPO was dried in a vacuum oven at 50° C. for 24 h. δH (500 MHz, CdCl3) 6.49 (1H 117 d), 6.10 (0.47H, d), 4.90 (0.94H, s), 2.10 (6H, t). CPPO was identified by NMR spectrum.

Quaternization of PPO with Trimethylamine (TMA), (QPPO):

4.0 g CPPO (30.0 mmol) was added to a 150 mL round bottom flask equipped with a stirring bar and dissolved in 130 mL NMP to yield a 3 wt % solution. The resulting mixture was brought to 40° C., treated with 5.1 mL of 3.2 M TMA/MeOH (16.3 mmol, 200% excess) and stirred for 6 h. Following, the reaction was heated at 70° C. for 24 h, and finally the vessel was opened at 80° C. for 2 h to evaporate any excess TMA. Without further workup, the resulting solution was then cast into a Teflon machined mold to form ˜50 μm thick membranes, further details below. 8H (500 MHz, d6-d6-DMSO) 6.6 (1H, s), 6.4 (0.13H, s), 6.3 (0.29H, s), 4.88 (0.81H, s) 3.24 (2.64H, t) 2.05 (m). QPPO was identified by NMR spectrum.

### Equilibration of Samples in Humidity

Samples are equilibrated in humidity by sealing a 3D printed cell for 72 hours with wells of saturated water/salt solution to vary relative humidity from 10 to 98% relative humidity. A saturated solution was used to control humidity, the aqueous saturated solution included NaCl, Na₂SO₄, and LiCl (in one example). The salts dilute the water and hinder escape of water molecules into the air. The rate of return of water molecules to the liquid surface is proportional to their concentration in the gas, where there are no salt ions to interfere. The system therefore adjusts to an equilibrium where there are fewer water molecules in the air than there would be over a pure water surface. The RH is therefore lower than 100%.

### Small Angle X-Ray Scattering

Characterization of the AEM nanostructure was carried out with SAXS. Measurements were conducted on a XEUSS 3.0 SAXS instrument (Xenocs, Inc, Grenoble, France) using a Cu k-alpha source with photon energy at 8.04 keV. Measurement geometry was calibrated with a silver behenate standard. Samples were prepared by mounting two pieces of a pre-treated membrane in their Cl-form in enclosed cells filled with DI water. Each cell consists of a silicone frame with polycarbonate or Kapton windows. The dry thickness of each sample is about 0.05 mm. All SAXS 2D images (measured on a Pilatus3 R 300K) were corrected for the X-ray transmission (measured directly on the image detector) prior to subtracting a background image from an empty cell filled with DI water. One-dimensional scattering profiles were computed via azimuthal integration of 2D-images.

The scattering data, I(q), was modeled as a function of the momentum transfer vector, q=4π/2 sin 2θ where λ is the X-ray wavelength and θ is the scattering angle, using the following:

$$l ( q ) = b + \frac{A}{{q}^{4}} + \{ \begin{matrix}\frac{G}{{q}^{s}} exp ( - \frac{{q}^{2} {R}_{g}^{2}}{3 - s} ) \\ \frac{D}{{q}^{d}} for q \geq {q}_{1}\end{matrix} for q < {q}_{1} , \qquad Equation 1$$

The first term, b, represents an additive incoherent background which includes electrolyte scattering. The second term represents scattering from meso-to-microscale inhomogeneities that is modeled as a Porod decay where A is a scale parameter. The final term represents the generalized Guinier-Porod model developed by Hammouda where R_{g} is the radius-of-gyration, sis a shape parameter, dis the Porod exponent, and G and D are scale factors related to the Guinier and the Porod contributions of the model. In order for the last term of Equation 1 to remain continuous in q-space, the following relationships are identified:

$${q}_{1} = \frac{1}{{R}_{g}} {( \frac{( d - s ) ( 3 - s )}{2} )}^{1 / 2} , \qquad Equation 2$$

$$D = G exp ( - \frac{{q}_{1}^{2} {R}_{g}^{2}}{3 - s} ) {q}_{1}^{( d - s )} \qquad Equation 3$$

For all SAXS modeling, b, A, R_{g}, and G, are open fit parameters.

For all samples, the additional constraints d=4, and s=0.3 are applied due to the limited q-range on either side of the scattering feature. The parameter s accounts for the general shape of the modeled structure: s=0 is for spherical objects (and the standard Guinier-law is recovered from Equations 2 and 3), s=1 is used for rod-like objects, and s=2 for used for lamellae or platelet-like objects. Values of s=0 and s=1 were both found to be insufficient in modeling the SAXS data. The choice of s=0.3 likely reflects an imperfect morphology consisting of a population with either 2 or 3-dimensional symmetric water channels.

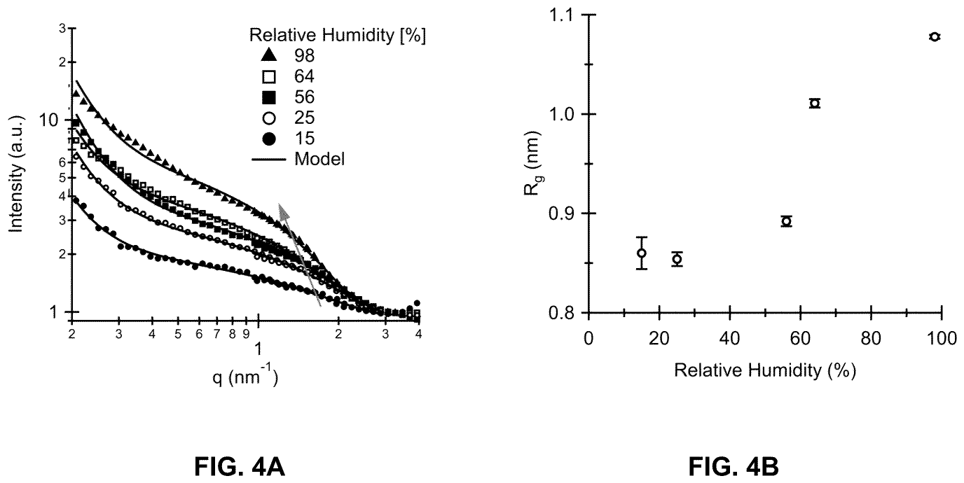

FIG. 4A gives results from SAXS which provides an estimation of the size of the nanostructure. The membranes under consideration here do not exhibit an ionomer peak typically found in sulfonic acid containing membranes, but they do include a knee-like feature that indicates nanoscale phase separation. Starting at the lowest relative humidity of 15% (●), and increasing to 25% (◯), 56% (▪), 64% (□), and 98% (▴) relative humidity (e.g., near 100% humidity) the knee shifts to lower values of q, shown by the arrow in FIG. 4A, which indicates a larger extent of phase-separation. The data was fitted using a modified Guinier-Porod model to extract a radius-of-gyration, R_{g}, that provides insight into the evolution of the nanoscale morphology. FIG. 4B gives R_{g} (y-axis) at varying Relative Humidity (x-axis). This measurement indicates that the length-scale associated with the water channels is greater when membranes are exposed to a higher hydration prior to crosslinking.

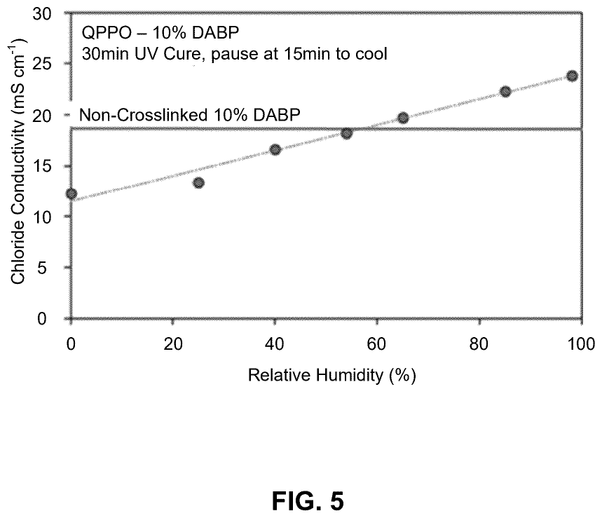

FIG. 5 illustrates the conductivity of chloride ions that are transported through the membrane. With increasing hydration at varying Relative Humidity (x-axis), the chloride conductivity of the membranes increases in a linear relationship. The solid circles correlate the measured conductivity of each membrane hydrated at a selected relative humidity followed by crosslinking. The solid horizontal line is a control sample with the same amount of concentration of the crosslinker additive (10% DABP) but the sample is not crosslinked. From a conductivity perspective, a higher hydration of the membrane before crosslinking results in a higher conductivity.

Moreover, the membrane selectively transports one ion and selectively excludes a different ion. For example, Cl ions may be transported through the membrane, but bulkier sulfide ions that have the same charge as Cl ions but are larger are excluded from being transported through the membrane. In another example, such as for fuel cells, charge exclusion may include exclusion of small positively charged species such as H⁺ ions.

### In Use

Various embodiments described herein may be developed for electrochemical devices such as water electrolyzers, CO₂ electrolyzers, N₂ electrolyzers, fuel cells, etc. Various embodiments described herein may be developed for batteries such as redox flow batteries, alkaline batteries, and polymer batteries. In some approaches, the process described herein may be used for chloralkali production. In some approaches, the process described herein may be used for production of commodity chemicals. In one approach, a process described may be useful for desalination processes, water treatment processes, etc. In one approach, a process as described herein may be useful for production of pharmaceuticals.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept, but should be defined only in accordance with the following claims and their equivalents.

What is claimed is:

1. A method of forming a membrane, the method comprising:
forming a membrane structure comprising a material, the material comprising a polymer, a crosslinking agent, and a solvent;
equilibrating the membrane structure at a selected relative humidity for a predefined duration of time for forming hydrophilic domains in the material, wherein the hydrophilic domains have a predefined average radius; and
curing the equilibrated membrane structure to crosslink the material to at least a predefined extent.

2. The method as recited in claim 1, wherein the selected relative humidity is in a range of greater than 10% up to less than 100% relative humidity.

3. The method as recited in claim 1, wherein the selected relative humidity is in a range of greater than 50% up to less than 100% relative humidity.

4. The method as recited in claim 1, wherein the membrane structure is not submerged in water before curing.

5. The method as recited in claim 1, wherein the crosslinking agent is a diazide crosslinking agent.

6. The method as recited in claim 5, wherein an amount of the diazide crosslinking agent is in a range of 0.25 weight % up to 10 weight % of the polymer.

7. The method as recited in claim 1, wherein the polymer is a quaternized poly(aryl ether) polymer.

8. The method as recited in claim 1, wherein curing includes heating at a temperature for thermal curing the equilibrated membrane structure for a predefined duration of time.

9. The method as recited in claim 1, wherein the membrane structure is a three-dimensional printed structure.

10. The method as recited in claim 1, wherein the curing includes exposure to radiation for a predefined duration of time.

11. The method as recited in claim 1, wherein the hydrophilic domains are self-assembled before curing.

12. A membrane, comprising:
a polymeric material having a plurality of hydrophilic domains, wherein the plurality of hydrophilic domains are configured to promote selective transport of a first ion and selective exclusion of a second ion,
wherein extents of the hydrophilic domains are defined by an interface of the polymeric material and a water channel,
wherein the hydrophilic domains have an average radius greater than about 0.2 nanometers up to less than 10 nanometers in the presence of water.

13. The membrane as recited in claim 12, wherein the membrane is a polyelectrolyte membrane.

14. The membrane as recited in claim 12, wherein the hydrophilic domains have an average radius in a range of greater than 0.5 nanometers to less than 5 nanometers in the presence of water.

15. The membrane as recited in claim 12, wherein the membrane is configured to have a predefined water content that is constant in the presence of a hydration condition.

16. The membrane as recited in claim 15, wherein the hydration condition includes a relative humidity in a range of greater than 10% relative humidity up to nearly 100% relative humidity.

17. The membrane as recited in claim 12, wherein the hydrophilic domains have an average radius greater than 0.6 nanometers up to less than 2 nanometers.

18. The membrane as recited in claim 12, wherein the polymeric material includes quaternized poly(aryl ether) polymers.
